(19) United States
(12) Patent Application Publication
(10) Pub. No.: US 2012/0050854 A1
(43) Pub. Date: Mar. 1, 2012

(54) REMOTE CONTROLLED TELESCOPE CLEANING SYSTEM FOR SMALL TELESCOPES

(76) Inventor: Robert S. Capon, Charlottesville, VA (US)

(21) Appl. No.: 12/873,671

(22) Filed: Sep. 1, 2010

(51) Int. Cl. G02B 23/16; G02B 23/02

(52) U.S. Cl. 359/399; 359/509

(57) ABSTRACT

The present invention relates to a remote-controlled telescope lens cleaning system and a telescope fitted with the same.

### FIELD OF THE INVENTION

The present invention relates to a remote-controlled telescope lens cleaning system and a telescope fitted with the same.

### BACKGROUND OF THE INVENTION

A Remotely Controlled Observatory (“RCO”) is an astronomical observatory that can be controlled by a person using a remote computer using a network connection to control an observatory computer, which in turn controls the electronic and electro-mechanical devices in the observatory (e.g., opening the observatory to the sky, controlling all aspects of the telescope, operating a lens cover if present).

Remotely controlled amateur observatories are becoming increasingly popular because of a number of inexpensive technologies that have become available. These technologies include personal computers, local area networks, wide area networks including the Internet, computer-controlled telescope mounts, computer-controlled focusing devices, sensitive computer-controlled CCD cameras, computer-controlled observatory domes and shutters, cloud and rain sensors, and sophisticated software tools for controlling each of these devices. These RCO's vary widely in sophistication, from modest backyard observatories that can be controlled from inside of a house, to sophisticated observatories that can be controlled over the Internet by an astronomer thousands of miles away.

While all of these functions exist today, at present there are no remotely-controlled telescope lens or mirror cleaning systems for amateur RCO's. The current state of the art for RCO's is to leave the lens cover off, and to place the telescope tube in the horizontal position so that the optical surfaces are vertical in order to mitigate the collection of dirt and dust on the optics while the telescope is not in use. Unfortunately, these telescopes are quickly covered by dust, dirt, pollen, insects, and other debris, and the optics need to be cleaned frequently. Because of the remote nature of the RCO's, accessing and cleaning the telescopes is often very difficult or impractical.

Thus, there is a need for a remotely-controlled cleaning system for telescopes in RCO's.

### SUMMARY OF THE INVENTION

The present invention provides a novel remotely controlled cleaning system (RCCS) for small telescopes, which is useful for Remotely Controlled Observatories (RCO's).

The present invention also provides a novel small telescope fitted with a remotely controlled cleaning system.

These and other aspects of the present invention have been accomplished in view of the discovery of a remotely controlled cleaning system as described herein.

### BRIEF DESCRIPTION OF THE DRAWINGS

FIG. 1 shows a remotely controlled observatory wherein observatory housing (1) with an operationally retractable opening (2) (e.g., a shutter) encloses a telescope (3) having optics (4) and fitted with a canister (7) having valve (6) and conduit (5), wherein the canister is operably connected to an observatory computer (8), which is electronically connected to a remotely-located computer (9).

FIG. 2 shows a remotely controlled observatory wherein observatory housing (1) with an operationally retractable opening (2) (e.g., a roll-off roof) encloses a telescope (3) having optics (4) and fitted with a canister (7) having valve (6) and conduit (5) with a plurality of terminal ends, wherein the canister is operably connected to an observatory computer (8), which is electronically connected to a remotely-located computer (9).

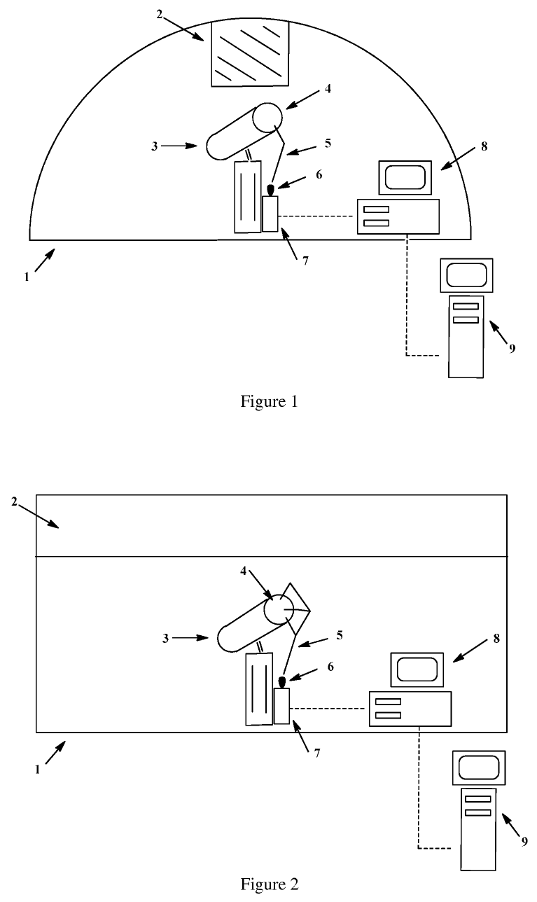

### DETAILED DESCRIPTION OF THE INVENTION

A small telescope is a telescope with an objective with a diameter of twenty-four inches or less (e.g., 24, 23, 22, 21, 20, 19, 18, 17, 16, 15, 14, 13, 12, 11, or 10). The telescope can be a reflecting telescope (including, without limitation, catadioptric telescopes such as a Schmidt Cassegrain or a Ritchey Chretien) with a primary minor and secondary minor or a refracting telescope with an objective lens system (with one or more corrective lens in the optical path).

The present invention enables an amateur astronomer, from a remote location, to periodically blow a gas across the telescope to clean the optics remotely. The remotely controlled cleaning system (RCCS) of the present invention, comprises: a canister (e.g., a hand-held can, tank, or cylinder, with examples of volumes including 0.25, 0.5, 1, 5, 10, 20, 30, 40, 50, 60, 70, 80, 90, 100 L) of a compressed gas (e.g., air, nitrogen, argon, or CO₂) that is fitted to the telescope through at least one conduit (e.g., tubing (e.g., rubber or plastic), piping (e.g., metal, plastic, or PVC or other polymeric materials). The canister also comprises a valve that is remotely controllable. The canister is operably connected to a computer residing in the RCO (the observatory computer). The observatory computer is operably connected to a computer remotely located outside of the RCO (the remote computer) and is capable of remotely controlling the cleaning system (as well as other remotely-controllable elements including the telescope).

The canister can be located in a number of places depending on the size of the canister, the size of the observatory, and the space available around the telescope. For example, the canister can be attached to the side of the telescope (e.g., typically if the canister is a hand-held size can or a small tank or cylinder), can be attached to the base of the telescope (e.g., typically if the canister is a tank or cylinder of limited size so as to not interfere with the rotation of the telescope) or can be located a distance from the telescope (e.g., typically if the canister is bulky tank or cylinder).

The conduit (or plurality of conduits, e.g., at least 2, 3, or 4) is fitted to the telescope such that the proximity of its terminal end (i.e., the end opposite the canister) allows the compressed gas from the canister, when its valve is opened by the observatory computer, to flow across the optics (e.g., lens, primary minor, and/or secondary minor) with sufficient velocity as to clean the optics (e.g., by dislodging particles residing on the optics). In another aspect, the conduit can be split into a plurality of conduits at any position along the length of the conduit including (a) near the canister to allow the plurality of conduits to terminate at various positions around the optics or (b) near the terminal end to allow for a plurality of end point at one position of the optics. In another aspect, the terminal end of the conduit, further comprises a nozzle (or plurality of nozzles if the conduit is split into more than one terminal point) that can focus or disperse the gas depending on the size of the optics to be cleaned and the desires of the operator.

In an aspect, the present invention provides a novel small telescope fitted with a remotely controlled cleaning system, comprising:

a. a telescope comprising an objective with a diameter of twenty four inches or less;

b. a container, comprising: an electro-mechanically controllable valve and compressed gas;

c. at least one conduit operably connected to the container and fitted within close proximity of the optics of the telescope;

d. an observatory computer operably connected to the canister;

e. software residing on the observatory computer capable of operating the canister; and,

f. a remotely-located computer electronically connected to the observatory computer and capable of controlling the observatory computer.

If the telescope comprises a primary and secondary minor, the cleaning system can clean one or both of the minors (e.g., when both minors are present and it is desirable to be able to clean both minors, then at least two conduits, at least one for each mirror, would connect the canister to each of the mirrors). Thus, in another aspect, the present invention provides a novel system wherein:

a. the telescope, comprises: a primary minor and a secondary mirror; and,

c. the at least one conduit comprises:
i. at least one first conduit operably connected to the container and fitted within close proximity of the primary mirror;
ii. at least one second conduit operably connected to the container and fitted within close proximity of the secondary minor.

In another aspect, when the telescope comprises at least two surfaces that are desirable to clean, the canister may comprise a first and second valve, wherein the first valve is connected to at least one first conduit that is within close proximity to a first surface and the second valve is connected to at least one second conduit that is within close proximity to a first surface. The observatory computer is capable to independently controlling the first and second valves, thereby allowing the astronomer the option of cleaning one or both surfaces independently.

Examples of connections between the observatory computer and the canister include an electronic cable and a wireless connection.

In another aspect, the present invention provides a novel small telescope fitted with a remotely controlled cleaning system, further comprising: a remotely controlled observatory, comprising an observatory housing, comprising: an operationally retractable portion capable of exposing the telescope to the sky, wherein the telescope fitted with a remotely controlled cleaning system is enclosed within the housing. Examples of the retractable portion include a shutter and a roll off roof.

In another aspect, software resides on both the remotely located computer and observatory computer so that the remotely located computer is capable of controlling the observatory computer. In addition to controlling the flow of gas from the canister, the observatory computer can also control the telescope (e.g., rotation and elevation) and the observatory housing (e.g., opening and closing the housing and rotating the housing). The controlling of the observatory computer can be achieved by the software on both computers in a number of ways including minoring the desktop of the observatory computer onto the remotely located computer.

In another aspect, the remotely located computer is connected to the observatory computer via a network. Examples of networks include the Internet, a wireless Ethernet network, and a wired Ethernet network.

After the gas is released from the canister and has flowed across the optics of the telescope, the resulting gas stream should be contain particulate matter (e.g., dust and pollen) removed from the optics. It may be desirable to remove this gas stream from the observatory housing (e.g., to prevent the particles from settling onto the optics of the telescope). In another aspect, the present invention further comprises: a means for removing at least a portion of the gas after having passed across the optics of the telescope, the means being operably connected to the optics. Typically, the means for removing at least a portion of the gas is located on the opposite side of the optics from the gas releasing end of at least one conduit and within close enough proximity to the gas stream to be capable of removing it. Removing can include capturing (e.g., using a vacuum cleaner that would then port the gas after passing it through a filter) and/or exhausting from the observatory housing (e.g., using a fan). The vacuum cleaner is operably connected to the optics of the telescope (e.g., via a conduit such as a hose). The body of the vacuum cleaner can be located where ever convenient (e.g., directly adjacent to the telescope, not adjacent but still inside the observatory housing, or outside of the observatory housing). The fan is operably connected to the optics of the telescope (e.g., via a conduit such as a hose or a vent shaft). Typically the exhaust of the fan is ported outside of the observatory housing (e.g., via a hose or a vent shaft). The fan can be located where ever convenient (e.g., directly adjacent to the telescope, not adjacent but still inside the observatory housing, outside of the observatory housing, or built into the housing). In another aspect, a fan and vacuum cleaner can be used in series to remove the dirty gas. For example, the vacuum cleaner can be used to collect the dirty gas and the fan can be use to remove the exhaust from the vacuum to the outside of the observatory housing. In another example, the fan can be used to deliver the dirty gas to the vacuum cleaner, which can then filter the dirty gas and exhaust clean gas (e.g., either inside of or outside of the observatory housing).

In another aspect, the present invention provides a novel small telescope fitted with a remotely controlled cleaning system, further comprising: an electro-mechanically controllable lens cover fitted to the telescope and capable of covering the optics of the telescope. A lens cover is a device to protect the optics of a telescope when the instrument is not in use. Lens covers are essential for protecting the telescope from accidental damage, and from keeping out dirt and dust when the telescope is not in use. An electro-mechanically controlled lens cover is a lens cover that is mechanically operated to cover and expose the optics of a small telescope. The mechanism that operates the lens cover is driven electronically, thereby allowing for remote operation.

The lens cover of the present invention can be embodied in a number of mechanical forms, depending on the desires of the operator. Examples of lens covers include (a) a lens cover that opens and closes like an iris; (b) a lens cover that opens and closes with a hinged cover that swings over the telescope optics; (c) a lens cover that opens and closes with multiple hinged covers that open and close like the petals of a flower over the telescope optics; and, (d) a lens cover that is a flexible cloth that rolls across the lens cover like a window-shade.

The examples provided in this application are non-inclusive unless otherwise stated. They include but are not limited to the recited examples.

Numerous modifications and variations of the present invention are possible in light of the above teachings. It is therefore to be understood that within the scope of the appended claims, the invention may be practiced other than as specifically described herein.

What is claimed:

1. A small telescope fitted with a remotely controlled cleaning system, comprising:
a. a telescope comprising an objective with a diameter of twenty four inches or less;
b. a container, comprising: an electro-mechanically controllable valve and compressed gas;
c. at least one conduit operably connected to the container and fitted within close proximity of the optics of the telescope;
d. an observatory computer operably connected to the canister;
e. software residing on the observatory computer capable of operating the canister; and,
f. a remotely-located computer electronically connected to the observatory computer and capable of controlling the observatory computer.

2. The system of claim 1, wherein:
a. the telescope, comprises: a primary mirror and a secondary mirror; and,
c. the at least one conduit comprises:
i. at least one first conduit operably connected to the container and fitted within close proximity of the primary mirror;
ii. at least one second conduit operably connected to the container and fitted within close proximity of the secondary minor.

3. The system of claim 1, wherein the observatory computer is connected to the canister cover via an electronic cable.

4. The system of claim 1, wherein the observatory computer is connected to the canister cover via a wireless connection.

5. The system of claim 1, further comprising: a remotely controlled observatory, comprising an observatory housing, comprising: an operationally retractable portion capable of exposing the telescope to the sky, wherein the telescope fitted with a remotely controlled cleaning system is enclosed within the housing.

6. The system of claim 6, wherein the retractable portion is a shutter.

7. The system of claim 6, wherein the retractable portion is a roll off roof.

8. The system of claim 1, wherein software resides on the remotely located computer and the observatory computer, which is capable of allowing the remotely located computer to control the observatory computer.

9. The system of claim 1, wherein the remotely located computer is connected to the observatory computer via a network.

10. The system of claim 1, further comprising: a means for removing at least a portion of the gas after having passed across the optics of the telescope, the means being operably connected to the optics.

11. The system of claim 10, wherein the means for removing is a vacuum cleaner.

12. The system of claim 10, wherein the means for removing is a fan.

13. The system of claim 1, further comprising: an electro-mechanically controllable lens cover fitted to the telescope and capable of covering the optics of the telescope.

14. The system of claim 13, wherein the lens cover opens and closes like an iris.

15. The system of claim 13, wherein the lens cover opens and closes with a hinged cover that swings over the telescope optics.

16. The system of claim 13, wherein the lens cover opens and closes with multiple hinged covers that open and close like the petals of a flower over the telescope optics.

17. The system of claim 13, wherein the lens cover is a flexible cloth that rolls across the lens cover like a window-shade.
